(19) United States
(12) Patent Application Publication
(10) Pub. No.: US 2025/0358581 A1
(43) Pub. Date: Nov. 20, 2025

(54) AUDIO UPMIXING METHOD AND AUDIO APPARATUS

(71) Applicant: Shenzhen Oceanwing Smart Innovations Technology Co., Ltd., Shenzhen (CN)

(72) Inventor: Taiyun Wu, Shenzhen (CN)

(21) Appl. No.: 19/201,320

(22) Filed: May 7, 2025

(30) Foreign Application Priority Data
May 16, 2024 (CN) 202410613182.3

(51) Int. Cl. H04S 5/00; G10L 21/0272; H04S 3/00; H04S 7/00

(52) U.S. Cl. CPC H04S 5/005; G10L 21/0272; H04S 3/008; H04S 7/30; H04S 2400/01; H04S 2400/03; H04S 2400/11

(57) ABSTRACT

An audio upmixing method and an audio apparatus are disclosed. The method comprises: performing feature extraction on a stereophonic audio signal to obtain a stereophonic audio feature; and extracting channel audio signals and right channel audio signals from the stereophonic audio feature based on audio output channels. The audio output channels are independent of each other, and each audio output channel is configured to output the corresponding left channel audio signal or the corresponding right channel audio signal. The method further comprises fusing the left channel audio signal and the right channel audio signal corresponding to a target channel to obtain first audio signals of a plurality of target channels. Each target channel corresponds to two audio output channels. The method further comprises outputting an audio upmixing signal of a target format based on the first audio signals. The target format corresponds to the plurality of target channels.

### CROSS-REFERENCE TO RELATED APPLICATION

The present disclosure claims priority to Chinese Patent Application No. 202410613182.3, filed on May 16, 2024, the entire disclosures of which are incorporated herein by reference.

### TECHNICAL FIELD

The present disclosure relates to the technical field of sound processing, and more particularly, to an audio upmixing method, an audio upmixing device, an audio apparatus, and a storage medium.

### BACKGROUND

With the development of sound processing technology, audio upmixing technology has emerged. This technology enables the conversion of a stereophonic audio signal into a desired audio upmixing signal, such as a 5.1-channel signal, a 7.1-channel signal, or a 7.1.2-channel signal.

In the related art, the desired audio upmixing signal is typically generated by decoding the stereophonic audio signal. For example, the stereophonic audio signal may be subjected to Dolby Pro Logic decoding to generate the 5.1-channel signal.

However, there are certain limitations with respect to the audio upmixing signal generated by decoding the stereophonic audio signal. On one hand, the positioning accuracy of audio signals across different channels remains questionable, which may result in poor spatial perception of the audio upmixing signal and thereby degrade the performance of audio upmixing. On the other hand, there may be a high degree of correlation between the audio signals of different channels, which further compromises the performance of the audio upmixing.

### SUMMARY

The disclosure provides an audio upmixing method, an audio upmixing device, an audio apparatus, and a storage medium, capable of improving the performance of the audio upmixing in view of the technical problems described above.

In a first aspect, the present disclosure provides an audio upmixing method comprising: obtaining a stereophonic audio signal, and performing feature extraction on the stereophonic audio signal to obtain a stereophonic audio feature; extracting, from the stereophonic audio feature and based on a plurality of audio output channels, a plurality of left channel audio signals and a plurality of right channel audio signals, where the plurality of audio output channels are independent of each other, and each of the plurality of audio output channels is configured to output the corresponding left channel audio signal or the corresponding right channel audio signal; fusing the left channel audio signal and the right channel audio signal corresponding to a particular target channel to obtain first audio signals of a plurality of target channels, where each of the plurality of target channels corresponds to two of the plurality of audio output channels; and outputting an audio upmixing signal of a target format based on the first audio signals of the plurality of target channels, where the target format corresponds to the plurality of target channels.

In an example, extracting the plurality of left channel audio signals and the plurality of right channel audio signals from the stereophonic audio feature includes: extracting a positional audio feature from the stereophonic audio feature, in which the positional audio feature is used to represent sound source signal features of different positions of the stereophonic audio signal; and extracting, from the positional audio feature and based on the plurality of target channels, the plurality of left channel audio signals and the plurality of right channel audio signals.

In an example, the positional audio feature includes a first positional sound source signal feature and a second positional sound source signal feature of the stereophonic audio signal, and the plurality of audio output channels include a plurality of first fully-connected networks and a plurality of second fully-connected networks that are different from each other. Extracting the plurality of left channel audio signals and the plurality of right channel audio signals from the positional audio feature includes: outputting, based on an input comprising the first positional sound source signal feature and using the plurality of first fully-connected networks, a corresponding left channel audio signal and a corresponding right channel audio signal, and each of the plurality of first fully-connected networks is configured to output the left channel audio signal or the right channel audio signal; and outputting, based on an input comprising the second positional sound source signal feature and using the plurality of second fully-connected networks, a corresponding left channel audio signal and a corresponding right channel audio signal, and each of the plurality of second fully-connected networks is configured to output the left channel audio signal or the right channel audio signal.

In an example, the first audio signals of the plurality of target channels include a first front left channel signal of a front left channel, a first front right channel signal of a front right channel, a first rear left channel signal of a rear left channel, a first rear right channel signal of a rear right channel, and a first center channel signal of a center channel. Fusing the left channel audio signal and the right channel audio signal corresponding to the target channel to obtain the first audio signals of the plurality of target channels includes: fusing a left channel audio signal and a right channel audio signal output by a first fully-connected network corresponding to the front left channel to obtain the first front left channel signal; fusing a left channel audio signal and a right channel audio signal output by the first fully-connected network corresponding to the front right channel to obtain the first front right channel signal; fusing a left channel audio signal and a right channel audio signal output by the first fully-connected network corresponding to the center channel to obtain the first center channel signal; fusing a left channel audio signal and a right channel audio signal output by the second fully-connected network corresponding to the rear left channel to obtain the first rear left channel signal; and fusing a left channel audio signal and a right channel audio signal output by the second fully-connected network corresponding to the rear right channel to obtain the first rear right channel signal.

In an example, obtaining the stereophonic audio signal includes: obtaining an original stereophonic signal, and performing voice separation on the original stereophonic signal to obtain a non-voice signal and a voice signal; and taking the non-voice signal as the stereophonic audio signal.

In an example, outputting the audio upmixing signal of the target format based on the first audio signals of the plurality of target channels includes: incorporating the voice signal into each of the front left channel signal, the front right channel signal, and the center channel signal in the first audio signals of the plurality of target channels to obtain second audio signals of the plurality of target channels; and outputting the audio upmixing signal of the target format based on the second audio signals of the plurality of target channels.

In an example, the first audio signals of the plurality of target channels include a first front left channel signal, a first front right channel signal, a first rear left channel signal, a first rear right channel signal and a first center channel signal, the voice signal includes a left channel voice signal and a right channel voice signal, and the second audio signals of the plurality of target channels include a second front left channel signal, a second front right channel signal, a second rear left channel signal, a second rear right channel signal, and a second center channel signal. Incorporating the voice signal into each of the front left channel signal, the front right channel signal, and the center channel signal in the first audio signals of the plurality of target channels to obtain second audio signals of the plurality of target channels includes: performing a weighted incorporation on the first front left channel signal and the left channel voice signal to obtain the second front left channel signal; performing the weighted incorporation on the first front right channel signal and the right channel voice signal to obtain the second front right channel signal; weighting the first rear left channel signal to obtain the second rear left channel signal, and weighting the first rear right channel signal into the second rear right channel signal; and performing the weighted incorporation on the left channel voice signal, the right channel voice signal, and the first center channel signal to obtain the second center channel signal.

In an example, the audio upmixing method is performed by an audio upmixing model, and the audio upmixing method further includes: obtaining 5.1-channel audio source signals, selecting a target audio source signal from each of the 5.1-channel audio source signals, and extracting, from the target audio signal, a 5-channel target audio signal; downmixing the 5-channel target audio signal to obtain a stereophonic training audio signal; extracting, from the stereophonic training audio signal based on the audio upmixing model, 5 channels of left channel audio signals and 5 channels of right channel audio signals, and incorporating the 5 channels of left channel audio signals and 5 channels of right channel audio signals into a 5-channel output audio signal; and optimizing the audio upmixing model based on a difference between the 5-channel target audio signal and the 5-channel output audio signal.

In an example, optimizing the audio upmixing model based on the difference between the 5-channel target audio signal and the 5-channel output audio signal includes: generating a first model loss based on an overall signal difference between the 5-channel target audio signal and the 5-channel output audio signal; generating a second model loss based on a first volume difference of audio signals of different channels in the 5-channel target audio signal and a second volume difference of audio signals of different channels in the 5-channel output audio signal; and optimizing the audio upmixing model based on the first model loss and the second model loss.

In a second aspect, the present disclosure further provides an audio apparatus. The audio apparatus includes a memory having a computer program stored thereon and a processor, where the processor, when executing the computer program, implements the following steps: obtaining a stereophonic audio signal, and performing feature extraction on the stereophonic audio signal to obtain a stereophonic audio feature; extracting, from the stereophonic audio feature and based on a plurality of audio output channels, a plurality of left channel audio signals and a plurality of right channel audio signals, where the plurality of audio output channels are independent of each other, and each of the plurality of audio output channels is configured to output the corresponding left channel audio signal or the corresponding right channel audio signal; fusing the left channel audio signal and the right channel audio signal corresponding to a particular target channel separately to obtain first audio signals of a plurality of target channels, where each of the plurality of target channels corresponds to two of the plurality of audio output channels; and outputting, based on the first audio signals of the plurality of target channels, an audio upmixing signal of a target format, where the target format corresponds to the plurality of target channels.

The audio upmixing method comprises: first obtaining a stereophonic audio signal, and performing feature extraction on the stereophonic audio signal to obtain a stereophonic audio feature; then extracting, from the stereophonic audio feature and based on a plurality of audio output channels, a plurality of left channel audio signals and a plurality of right channel audio signals, where each of the plurality of audio output channels is configured to output the corresponding left channel audio signal or the corresponding right channel audio signal, and since the plurality of audio output channels are independent of each other, the left channel audio signals output by the plurality of audio output channels are different and do not interfere with each other, and likewise, the right channel audio signals output by the plurality of audio output channels are different and do not interfere with each other, which contribute to reducing the correlation between the left channel audio signals output by the plurality of audio output channels and the correlation between the right channel audio signals output by the plurality of audio output channels; next fusing the left channel audio signal and the right channel audio signal corresponding to a particular target channel to obtain first audio signals of a plurality of target channels, where each of the plurality of target channels corresponds to two of the plurality of audio output channels; and finally outputting, based on the first audio signals of the plurality of target channels, an audio upmixing signal of a target format corresponding to the plurality of target channels. On one hand, since the left channel audio signals output by the plurality of audio output channels are different and do not interfere with each other, and the right channel audio signals output by the plurality of audio output channels are different and do not interfere with each other, the correlation between the first audio signals of the plurality of target channels can be reduced, and the performance of the audio upmixing can be improved; on the other hand, since the audio output channels are independent of each other, and the corresponding first audio signal is generated for each of the plurality of target channels respectively according to the present disclosure, the first audio signals of the plurality of target channels do not interfere with each other, the positioning accuracy is higher, and the spatial perception of the output audio upmixing signal of the target format is better. Thus, the performance of the audio upmixing can be further improved.

### BRIEF DESCRIPTION OF THE DRAWINGS

FIG. 1 is a schematic flowchart of an audio upmixing method according to an example of the present disclosure;

FIG. 2 is a schematic diagram of feature extraction of a stereophonic audio signal according to an example of the present disclosure;

FIG. 3 is a schematic flowchart of extracting a plurality of left channel audio signals and a plurality of right channel audio signals from a stereophonic audio feature based on a plurality of audio output channels according to an example of the present disclosure;

FIG. 4 is a schematic diagram of generating audio signals of a plurality of target channels based on a first positional sound source signal feature and a second positional sound source signal feature according to an example of the present disclosure;

FIG. 5 is a schematic diagram of generating a 5.1-channel audio signal based on an original stereophonic signal according to an example of the present disclosure;

FIG. 6 is a schematic diagram of generating a 5.1-channel audio signal based on an original stereophonic signal according to another example of the present disclosure;

FIG. 7 is a structural block diagram of an audio upmixing device according to an example of the present disclosure; and

FIG. 8 is an internal structural diagram of an audio apparatus according to an example of the present disclosure.

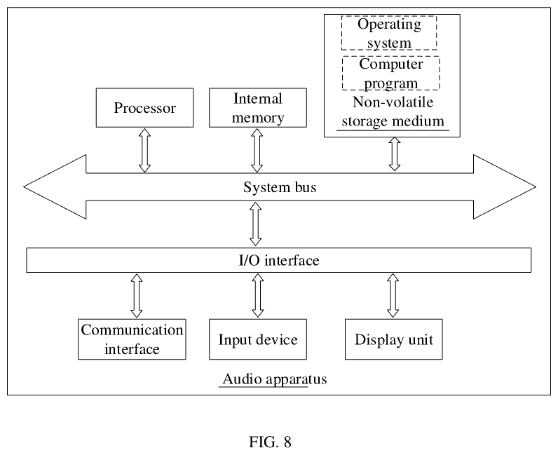

### DETAILED DESCRIPTION

The present disclosure will be described in detail with reference to the accompanying drawings and examples. It should be understood that the examples described here are only used to explain, rather than limiting, the present disclosure.

It should be noted that, in order to enhance the spatial perception during playback, it is common practice to convert a stereophonic audio signal into an audio upmixing signal, such as a 5.1-channel audio signal. Currently, Dolby Pro Logic decoding is usually used to directly decode the stereophonic audio signal into the 5.1-channel audio signal. In the related art, on one hand, the positioning accuracy of audio signals across different channels remains questionable, which may result in poor spatial perception of the audio upmixing signal and thereby degrade the performance of audio upmixing; on the other hand, there may be a high degree of correlation between the audio signals of different channels, which further compromises the performance of the audio upmixing.

It should be noted that the audio upmixing signal generated in the present disclosure is not limited to the 5.1-channel audio signal, but may also be a 7.1-channel audio signal or a 7.1. 2-channel audio signal, or the like, and the user may select it according to actual needs. The audio upmixing method of the present disclosure may be applied to an audio apparatus. The audio apparatus may be an earphone, a speaker, a home theater type audio apparatus, a hearing aid device, or the like, which is not limited herein.

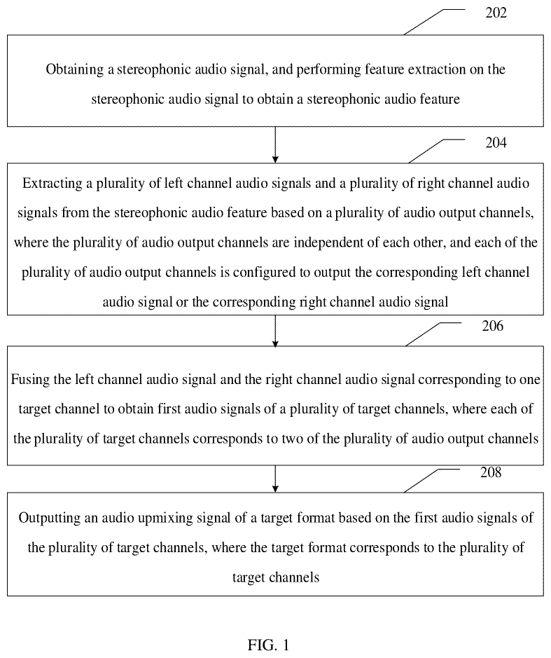

In an example, as shown in FIG. 1, an audio upmixing method is provided. The method includes the following steps. At step 202, a stereophonic audio signal is obtained, and feature extraction is performed on the stereophonic audio signal to obtain a stereophonic audio feature.

The stereophonic audio signal is an audio signal with stereoscopic sense, and is usually composed of a left channel audio signal and a right channel audio signal. The stereophonic audio feature is a high-dimensional feature representing a signal feature of the stereophonic audio signal, and may be, for example, a high-dimensional feature matrix, or the like. The audio apparatus may request the stereophonic audio signal from an external device, so that the external device may transmit the stereophonic audio signal to the audio apparatus. Additionally or alternatively, the audio apparatus may directly obtain the stereophonic audio signal from locally stored audio data.

As an example, the stereophonic audio signal may be an original stereophonic signal obtained via collection, where the original stereophonic signal is composed of a voice signal and a non-voice signal. The stereophonic audio signal may also be an original stereophonic signal subsequent to the voice signal being separated (e.g., the non-voice signal in the original stereophonic signal).

As an example, step 202 includes: obtaining the stereophonic audio signal; converting the stereophonic audio signal from a time domain to a frequency domain to obtain a stereophonic frequency domain signal; performing frequency division on the stereophonic frequency domain signal to obtain a plurality of frequency-divided signals; then performing feature extraction on the plurality of frequency-divided signals respectively to obtain a plurality of frequency-divided signal features; and based to a frequency division band bandwidth, fusing the plurality of frequency-divided signal features to obtain the stereophonic audio feature. In this way, since the stereophonic frequency domain signal is frequency-divided prior to the feature extraction, the granularity of the feature extraction is finer and the accuracy of the feature extraction is improved. As a result, the accuracy of the final stereophonic audio feature is also improved.

As an example, step 202 includes: converting the stereophonic audio signal from a time domain to a frequency domain to obtain a stereophonic frequency domain signal; and performing feature extraction on the stereophonic frequency domain signal to obtain the stereophonic audio feature.

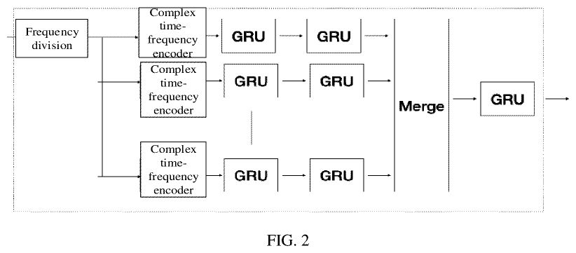

As an example, in the example, a series of GRU modules may be used as feature extraction modules to realize the feature extraction function. Referring to FIG. 2 in detail, FIG. 2 is a schematic diagram of the feature extraction of the stereophonic audio signal to obtain the stereophonic audio feature according to an example. In the example, subsequent to converting the stereophonic audio signal from the time domain to the frequency domain to obtain the stereophonic frequency domain signal, the stereophonic frequency domain signal is first input into a frequency division module to obtain the frequency-divided signals under a plurality of frequency division bands. And each of the frequency-divided signals under the plurality of frequency division bands is input into a corresponding complex time-frequency encoder respectively for feature coding, to obtain coded features of the frequency-divided signals under the plurality of frequency division bands. The coded features of the frequency-divided signals under the plurality of frequency division bands are then respectively subjected to a series of GRU modules (feature extraction modules), to obtain frequency-divided features extracted under the plurality of frequency division bands. Then, the frequency-divided features under the plurality of frequency division bands are subjected to feature fusion through a Merge (feature fusion module) to obtain a fused feature. Finally, by processing the fused feature through a GRU module, the fused feature is mapped to a predetermined feature dimension, and the final stereophonic audio feature is obtained.

At step 204, a plurality of left channel audio signals and a plurality of right channel audio signals are extracted from the stereophonic audio feature based on a plurality of audio output channels. The plurality of audio output channels are independent of each other, and each of the plurality of audio output channels is configured to output the corresponding left channel audio signal or the corresponding right channel audio signal.

In the example, the plurality of audio output channels are independent of each other and capable of outputting the left channel audio signals and the right channel audio signals to which different weights are added, and a particular audio output channel is capable of outputting the corresponding left channel audio signal or the corresponding right channel audio signal. In this way, since these audio output channels are independent of each other, the left channel audio signals and the right channel audio signals output from the audio output channels are different and have low correlation.

As an example, step 204 includes: inputting the stereophonic audio feature into the plurality of audio output channels respectively, and outputting the plurality of left channel audio signals and the plurality of right channel audio signals. Each of the plurality of audio output channels is configured to map the stereophonic audio feature into the corresponding left channel audio signal or the corresponding right channel audio signal, and a mapping parameter of each of the plurality of audio output channels varies. In this way, the output plurality of left channel audio signals and the output plurality of right channel audio signals have low correlation.

At step 206, the left channel audio signal and the right channel audio signal corresponding to a particular target channel are fused to obtain first audio signals of a plurality of target channels. Each of the plurality of target channels corresponds to two of the plurality of audio output channels.

The number and type of the plurality of target channels are determined by a target format of the audio upmixing signal finally generated. Taking the audio upmixing signal as a 5.1-channel audio signal as an example, the plurality of target channels include a front left channel, a front right channel, a rear left channel, a rear right channel, and a center channel. The first audio signals of the plurality of target channels are a first front left channel signal, a first front right channel signal, a first rear left channel signal, a first rear right channel signal, and a first center channel signal.

It should be noted that, in the example, there is a correspondence between the plurality of target channels and the plurality of audio output channels. Every two of the plurality of audio output channels correspond to a particular target channel. The two audio output channels corresponding to each of the plurality of target channels output the left channel audio signal and the right channel audio signal respectively. Thus, each of the plurality of target channels corresponds to one left channel audio signal and one right channel audio signal.

As an example, step 206 includes: obtaining, for each of the plurality of target channels, the left channel audio signal and the right channel audio signal output from the two audio output channels corresponding to the target channel, weighting the left channel audio signal and the right channel audio signal respectively, and fusing the weighted left channel audio signal and the weighted right channel audio signal to obtain the first audio signal of the target channel. In this way, by setting the correspondence between the target channel and the audio output channel, the left channel audio signal and the right channel audio signal output from different audio output channels can be incorporated into the first audio signal under the target channel. Since the audio output channels are independent of each other and do not interfere with each other, the correlation between the first audio signals under the target channels obtained by incorporation is kept low, and the positioning is more accurate, thus improving the performance of the audio upmixing.

At step 208, an audio upmixing signal of a target format is output based on the first audio signals of the plurality of target channels. The target format corresponds to the plurality of target channels. As an example, step 208 includes incorporating the first audio signals of the plurality of target channels to obtain the audio upmixing signal of the target format.

As an example, the audio upmixing signal of the target format is a 5.1-channel audio signal. Step 208 includes: low-pass filtering an original stereophonic signal corresponding to the stereophonic audio signal to obtain a bass channel signal; and incorporating the bass channel signal, the first front left channel signal, the first front right channel signal, the first rear left channel signal, the first rear right channel signal, and the first center channel signal to obtain the 5.1-channel audio signal.

The audio upmixing method includes: first obtaining a stereophonic audio signal, and performing feature extraction on the stereophonic audio signal to obtain a stereophonic audio feature; then extracting a plurality of left channel audio signals and a plurality of right channel audio signals from the stereophonic audio feature based on a plurality of audio output channels, where each of the plurality of audio output channels is configured to output the corresponding left channel audio signal or the corresponding right channel audio signal. Since the plurality of audio output channels are independent of each other, the left channel audio signals output by the plurality of audio output channels are different and do not interfere with each other. Likewise, the right channel audio signals output by the plurality of audio output channels are different and do not interfere with each other, reducing the correlation between the left channel audio signals output by the plurality of audio output channels and the correlation between the right channel audio signals output by the plurality of audio output channels. Next, fusing the left channel audio signal and the right channel audio signal corresponding to a particular target channel to obtain first audio signals of a plurality of target channels, where each of the plurality of target channels corresponds to two of the plurality of audio output channels. Finally, outputting an audio upmixing signal of a target format corresponding to the plurality of target channels based on the first audio signals of the plurality of target channels. On one hand, since the left channel audio signals output by the plurality of audio output channels are different and do not interfere with each other, and the right channel audio signals output by the plurality of audio output channels are different and do not interfere with each other, the correlation between the first audio signals of the plurality of target channels can be reduced, and the performance of the audio upmixing can be improved. On the other hand, since the audio output channels are independent of each other, and the corresponding first audio signal is generated for each of the plurality of target channels respectively according to the present disclosure, the first audio signals of the plurality of target channels do not interfere with each other, the positioning accuracy is higher, and the spatial perception of the output audio upmixing signal of the target format is better. Thus, the performance of the audio upmixing can be further improved.

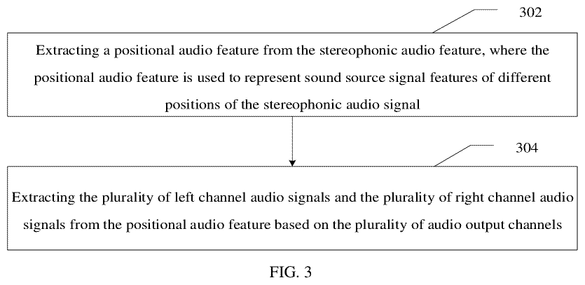

In an example, as illustrated in FIG. 3, extracting the left channel audio signals and the right channel audio signals output from the plurality of audio output channels from the stereophonic audio feature further includes the following steps. At step 302, a positional audio feature is extracted from the stereophonic audio feature. The positional audio feature is used to represent sound source signal features of different positions of the stereophonic audio signal.

One or more positional audio features may correspond to the stereophonic audio feature, which is not limited herein. The positional audio feature may be, for example, a first positional sound source signal feature representing a front positional audio feature or a second positional audio signal feature representing a rear positional audio feature.

As an example, step 302 includes extracting the corresponding positional audio feature from the stereophonic audio feature based on at least one predetermined positional feature extraction module. The predetermined positional feature extraction module is configured to extract the positional audio feature representing a sound source signal feature in a predetermined position from the stereophonic audio feature. As an example, the predetermined positional feature extraction module may be a GRU (gated recurrent unit) module.

At step 304, the plurality of left channel audio signals and the plurality of right channel audio signals are extracted from the positional audio feature based on the plurality of audio output channels. As an example, step 304 includes, for each positional audio feature, taking the positional audio feature as an input of the corresponding audio output channel, and mapping the positional audio feature into the corresponding left channel audio signal and the corresponding right channel audio signal through the audio output channel corresponding to the positional audio feature.

As an example, when the final generated audio upmixing signal is a 5.1-channel audio signal, the different positions may be a front left position (corresponding to a front left channel in a 5.1 channel), a front right position (corresponding to a front right channel in the 5.1 channel), a rear left position (corresponding to a rear left channel in 5.1 channel), a rear right position (corresponding to a rear right channel in the 5.1 channel), and a center position (corresponding to a center channel in the 5.1 channel).

In this way, by dividing the stereophonic audio feature into at least one positional audio feature to generate the left channel audio signals and the right channel audio signals,, this approach may minimize or prevent interference between the sound source signal features from different positions within the stereophonic audio feature, thereby helping to improve the accuracy of the final left channel audio signals and the final right channel audio signals.

In an example, the positional audio feature includes a first positional sound source signal feature and a second positional sound source signal feature of the stereophonic audio signal. The predetermined positional feature extraction module includes a first positional feature extraction module and a second positional feature extraction module. Extracting the plurality of left channel audio signals and the plurality of right channel audio signals from the positional audio feature based on the plurality of audio output channels includes: extracting the first positional sound source signal feature from the stereophonic audio feature based on the first positional feature extraction module, and extracting the second positional sound source signal feature from the stereophonic audio feature based on the second positional feature extraction module.

As an example, the first positional sound signal feature may be a positional signal feature representing a front sound source signal feature of the stereophonic audio signal, and the second positional sound signal feature may be a positional signal feature representing a rear sound source signal feature of the stereophonic audio signal.

As an example, the first positional sound signal feature may be a positional signal feature representing a left front sound source signal feature of the stereophonic audio signal, and the second positional sound signal feature may be a positional signal feature representing a rear right sound source signal feature of the stereophonic audio signal.

The aforementioned first positional sound source signal feature and the second positional sound source signal feature are specifically used to indicate the sound source signal feature from which position of the stereophonic audio signal, which is not limited herein, and can be selected according to actual needs.

In an example, the positional audio feature includes a first positional sound source signal feature and a second positional sound source signal feature of the stereophonic audio signal, and the plurality of audio output channels include a plurality of first fully-connected networks and a plurality of second fully-connected networks that are different from each other; and said extracting the plurality of left channel audio signals and the plurality of right channel audio signals from the positional audio feature based on the plurality of audio output channels includes: outputting a corresponding left channel audio signal and a corresponding right channel audio signal through the plurality of first fully-connected networks by taking the first positional sound source signal feature as an input to the first fully-connected networks, each of the plurality of first fully-connected networks being configured to output the left channel audio signal or the right channel audio signal; and outputting a corresponding left channel audio signal and a corresponding right channel audio signal through the plurality of second fully-connected networks by taking the second positional sound source signal feature as an input to the second fully-connected networks, each of the plurality of second fully-connected networks being configured to output the left channel audio signal or the right channel audio signal.

Each of the plurality of audio output channel may include a first fully-connected network or a second fully-connected network. Each first fully-connected network is different from the corresponding second fully-connected network Specifically, for each first fully-connected network, the first positional sound source signal feature is designated as an input to the first fully-connected network, the first positional sound source signal feature is fully connected through the first fully-connected network, and subsequent to the full connection, the left channel audio signal or the right channel audio signal output by the first fully-connected network is obtained through a predetermined activation function. For each second fully-connected network, the second positional sound source signal feature is designated as an input to the second fully-connected network, the second positional sound source signal feature is fully connected through the second fully-connected network, and subsequent to the full connection, the left channel audio signal or the right channel audio signal output by the second fully-connected network is obtained through a predetermined activation function.

In the example, the first positional sound source signal feature and the second positional sound source signal feature of the stereophonic audio signal are firstly separated from the stereophonic audio feature. Then, for the first positional sound source signal feature, the left channel audio signals and the right channel audio signals output from the plurality of audio output channels are extracted. For the second positional sound source signal feature, the left channel audio signals and the right channel audio signals output from the plurality of audio output channels are extracted. In this way, the left channel audio signals and the right channel audio signals can be generated subsequent to separating the sound source signal features of different positions in the stereophonic audio feature. In the process of generating the left channel audio signals and the right channel signals, the sound source signal features of different positions in the stereophonic audio feature do not interfere with each other, thereby improving the accuracy of the generated left channel audio signals and the right channel audio signals.

It should also be noted that the greater the number of the positional audio features divided or extracted from the stereophonic audio feature, the more accurate the generated final left channel audio signals and the final right channel audio signals will be. Accordingly, the greater the number of the positional audio features divided or extracted from the stereophonic audio feature, the lower the efficiency of generating the left channel audio signals and the right channel audio signals will be. In the example, the first positional sound source signal feature and the second positional sound source signal feature of two positions are divided or extracted from the stereophonic audio feature. The left channel audio signals and the right channel audio signals output from the plurality of audio output channels are generated by using the first positional sound source signal feature and the second positional sound source signal feature. In this way, the generation efficiency and the generation accuracy of the left channel audio signals and the right channel audio signals can be balanced.

In an example, the 5.1-channel audio signal to be generated is described herein. The first audio signals of the plurality of target channels include a first front left channel signal of a front left channel, a first front right channel signal of a front right channel, a first rear left channel signal of a rear left channel, a first rear right channel signal of a rear right channel, and a first center channel signal of a center channel. The fusing the left channel audio signal and the right channel audio signal corresponding to a particular target channel to obtain the first audio signals of the plurality of target channels includes: fusing a left channel audio signal and a right channel audio signal output by the first fully-connected network corresponding to the front left channel to obtain the first front left channel signal; fusing a left channel audio signal and a right channel audio signal output by the first fully-connected network corresponding to the front right channel to obtain the first front right channel signal; fusing a left channel audio signal and a right channel audio signal output by the first fully-connected network corresponding to the center channel to obtain the first center channel signal; fusing a left channel audio signal and a right channel audio signal output by the second fully-connected network corresponding to the rear left channel to obtain the first rear left channel signal; and fusing a left channel audio signal and a right channel audio signal output by the second fully-connected network corresponding to the rear right channel to obtain the first rear right channel signal.

Specifically, according to the correspondence between the target channel and the audio output channel, in the left channel audio signals and the right channel audio signals output by different first fully-connected networks, the left channel audio signals and the right channel audio signals corresponding to the front left channel, the left channel audio signals and the right channel audio signals corresponding to the front right channel, and the left channel audio signals and the right channel audio signals corresponding to the center channel are determined. A weighted fusion is performed on the left channel audio signals and the right channel audio signals corresponding to the front left channel to obtain a first front left channel signal. The weighted fusion is performed on the left channel audio signals and the right channel audio signals corresponding to the front right channel to obtain a first front right channel signal. The weighted fusion is performed on the left channel audio signals and the right channel audio signals corresponding to the center channel to obtain a first center channel signal. According to the correspondence between the target channel and the audio output channel, in the left channel audio signals and the right channel audio signals output by different second fully-connected networks, left channel audio signals and right channel audio signals corresponding to a rear left channel and left channel audio signals and right channel audio signals corresponding to a rear right channel are determined. The weighted fusion is performed on the left channel audio signals and the right channel audio signals corresponding to the rear left channel to obtain a first rear left channel signal. The weighted fusion is performed on the left channel audio signals and the right channel audio signals corresponding to the rear right channel to obtain a first rear right channel signal.

In the example, different first fully-connected networks and different second fully-connected networks are provided to generate the left channel audio signals. The right channel audio signals that are different from each other and do not interfere with each other. In this way, by performing the weighted fusion on the left channel audio signals and the right channel audio signals output by different first fully-connected networks respectively, the first front left channel signal, the first front right channel signal, and the first center channel signal are generated. And by performing the weighted fusion on the left channel audio signals and the right channel audio signals output by different second fully-connected networks respectively, the first rear left channel signal and the first rear right channel signal are generated. By combining the left channel audio signals and the right channel audio signals that are different from each other and do not interfere with each other, it can be further ensured that the first front left channel signal, the first front right channel signal, the first center channel signal, the left channel audio signal, and the right channel audio signal that are obtained subsequent to the incorporation are different from each other and do not interfere with each other, either. Thus, the positioning accuracy of the spatial position of the 5.1-channel audio signal can be improved, and the correlation between the audio signals of different channels can be reduced, which helps to improve the performance of the audio upmixing.

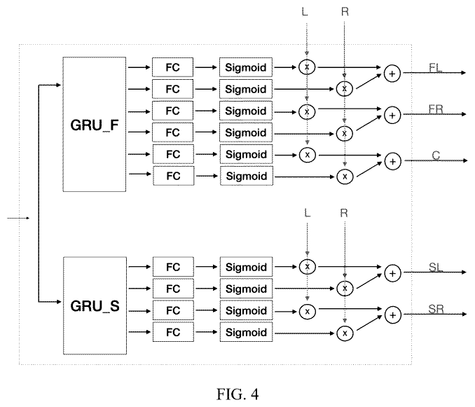

In an example, referring to FIG. 4, FIG. 4 is a schematic diagram of generating audio signals of target channels in a 5.1-channel audio signal based on a first positional sound source signal feature and a second positional sound source signal feature according to an example. GRU_F is a first positional feature extraction module and is configured to extract the first positional sound source signal feature of the stereophonic audio signal from the stereophonic audio feature. GRU_S is a second positional feature extraction module and is configured to extract the second positional sound source signal feature of the stereophonic audio signal from the stereophonic audio feature. An FC module connected with GRU_F is a first fully-connected network, and each first fully-connected network is connected with an activation function Sigmoid. An FC module connected with GRU_S is a second fully-connected network, and each second fully-connected network is connected with an activation function Sigmoid. L represents an output left channel audio signal, R represents an output right channel audio signal, FL represents a first front left channel signal, FR represents a first front right channel signal, C represents a first center channel signal, SL represents a first rear left channel signal, SR represents a first rear right channel signal, and ⊕ represents the weighted fusion. As an example, the weighted fusion may be performed by multiplying the output left channel signal and the output right channel signal by a corresponding mask respectively, and then adding the multiplied signals.

In an example, obtaining a stereophonic audio signal includes: obtaining an original stereophonic signal, and performing voice separation on the original stereophonic signal to obtain a non-voice signal and a voice signal; and taking the non-voice signal as the stereophonic audio signal.

In order to maintain the integrity of the voice, in the example, the voice signal in the original stereophonic signal can be separated prior to an audio downmixing being performed, so that the stereophonic audio signal excluding the voice signal can be obtained.

As an example, the original stereophonic signal may also be directly designated as the stereophonic audio signal, so that the voice signal may be exist in the stereophonic audio signal.

In an example, outputting the audio upmixing signal of the target format based on the first audio signals of the plurality of target channels includes: incorporating the voice signal into each of the front left channel signal, the front right channel signal, and the center channel signal in the first audio signals of the plurality of target channels to obtain second audio signals of the plurality of target channels; and outputting the audio upmixing signal of the target format based on the second audio signals of the plurality of target channels.

For the audio upmixing signal, the voice signal usually exists in the front left channel, the front right channel, and the center channel, which can give the user a better auditory experience. Taking the 5.1-channel audio signal as an example, usually the voice signal exists in the front left channel, the front right channel, and the center channel, while no voice signal exists in the rear left channel and rear right channel, which makes the auditory experience of the 5.1-channel audio signal better. Therefore, subsequent to obtaining the first audio signals of the plurality of target channels and prior to finally generating the audio upmixing signal of the target format, the voice signal is incorporated into the first audio signals of the plurality of target channels. In this way, the finally generated the audio upmixing signal of the target format can have a complete voice signal, and since the voice signal does not subject to a series of audio upmixing operations following the stereophonic audio signal, the distortion of the voice signal in the audio upmixing process can be avoided, the authenticity and the integrity of the voice signal can be ensured, and the performance of the audio upmixing can be further improved.

Specifically, the voice signal is weighted and fused into each of the front left channel signal, the front right channel signal, and the center channel signal in the first audio signals of the plurality of target channels respectively, to obtain second audio signals of the plurality of target channels. The second audio signals of the plurality of target channels are incorporated into the audio upmixing signal of the target format.

In the example, after separating the voice signal from the original stereophonic signal and after generating the first audio signals of the plurality of target channels based on the stereophonic audio signal obtained by separating the voice signal, the voice signal is incorporated only into each of the front left channel signal, the front right channel signal, and the center channel signal in the first audio signals of the plurality of target channels. This achieves selective audio rendering of the first audio signals of the plurality of target channels. In this way, the generated second audio signals of the plurality of target channels are better aligned with the user's auditory habit and provide an improved auditory experience, thereby enhancing the overall performance of the audio upmixing.

In an example, the audio upmixing signal of the target format is a 5.1-channel audio signal. The first audio signals of the plurality of target channels include a first front left channel signal, a first front right channel signal, a first rear left channel signal, a first rear right channel signal and a first center channel signal. The voice signal includes a left channel voice signal and a right channel voice signal, and the second audio signals of the plurality of target channels include a second front left channel signal, a second front right channel signal, a second rear left channel signal, a second rear right channel signal, and a second center channel signal. The incorporating the voice signal into each of the front left channel signal, the front right channel signal, and the center channel signal in the first audio signals of the plurality of target channels to obtain second audio signals of the plurality of target channels includes: performing a weighted incorporation on the first front left channel signal and the left channel voice signal to obtain the second front left channel signal; performing the weighted incorporation on the first front right channel signal and the right channel voice signal to obtain the second front right channel signal; weighting the first rear left channel signal to obtain the second rear left channel signal, and weighting the first rear right channel signal into the second rear right channel signal; and performing the weighted incorporation on the left channel voice signal, the right channel voice signal, and the first center channel signal to obtain the second center channel signal.

Specifically, the first front left channel signal is weighted based on a first predetermined weight, a left channel voice signal is weighted based on a second predetermined weight, and the weighted first front left channel signal and the weighted left channel voice signal are added to obtain a second front left channel signal. The first front right channel signal is weighted based on the first predetermined weight, a right channel voice signal is weighted based on the second predetermined weight, and the weighted first front right channel signal and the weighted right channel voice signal are added to obtain a second front right channel signal. The first rear left channel signal and the first rear right channel signal are weighted respectively based on a third predetermined weight to obtain a second rear left channel signal corresponding to the first rear left channel signal and a second rear right channel signal corresponding to the first rear right channel signal. The first center channel signal is weighted based on a fourth predetermined weight, and the left channel voice signal and the right channel voice signal based on a fifth predetermined weight respectively, and the weighted first center channel signal, the weighted left channel voice signal, and the weighted right channel voice signal are added to obtain a second center channel signal.

Further, the original stereophonic signal may be low-pass filtered, and the low-pass filtered original stereophonic signal is weighted based on a sixth predetermined weight to obtain the bass channel signal. Then, the second front left channel signal, the second front right channel signal, the second center channel signal, the second rear left channel signal, the second rear right channel signal, and the bass channel signal may be collectively designated as the 5.1-channel audio signal.

As an example, the first predetermined weight is used to characterize importance of non-voice in a front surrounding channel (including a front left channel and a front right channel) to the 5.1-channel audio signal. The greater the importance of the non-voice in the front surrounding channel is, the higher the first predetermined weight is. The second predetermined weight is used to characterize the importance of voice in the front surrounding channel to the 5.1-channel audio signal. The greater the importance of the voice in the front surrounding channel is, the higher the second predetermined weight is. The third predetermined weight is used to characterize the importance of the non-voice in a rear surrounding channel (including a rear left channel and a rear right channel) to the 5.1-channel audio signal. The greater the importance of the non-voice in the rear surrounding channel is, the higher the third predetermined weight is. The fourth predetermined weight is used to characterize the importance of the non-voice in a center channel to the 5.1-channel audio signal. The greater the importance of the non-voice in the center channel is, the higher the fourth predetermined weight is. The fifth predetermined weight is used to characterize the importance of the voice in the center channel to the 5.1-channel audio signal. The greater the importance of the voice in the center channel is, the higher the fifth predetermined weight is. The sixth predetermined weight is used to characterize the importance of a bass channel signal to the 5.1-channel audio signal. The greater the importance of the bass channel signal is, the higher the sixth predetermined weight is.

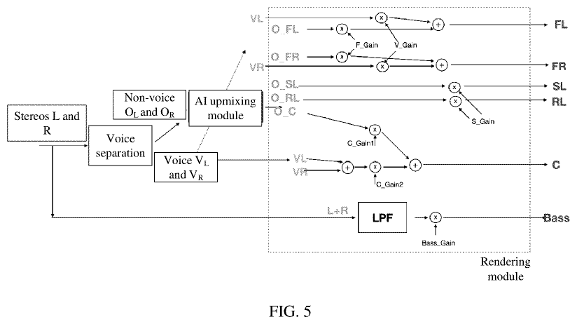

In an example, the finally generated audio upmixing signal of the target format is a 5.1-channel audio signal. Referring to FIG. 5, FIG. 5 is a schematic diagram of generating the 5.1-channel audio signal based on the original stereophonic signal according to an example. Stereos L and R are original stereophonic signals, a voice VL is a left channel voice signal, a voice VR is a right channel voice signal, a non-voice is a stereophonic audio signal. An AI upmixing module is configured to generate first audio signals of a plurality of target channels based on the non-voice. The first audio signals of the plurality of target channels include a first front left channel signal O_FL, a first front right channel signal O_FR, a first rear left channel signal O_SL, a first rear right channel signal O_RL, a first center channel signal O_C. LPF is a low-pass filter, F_Gain is a first predetermined weight, V_Gain is a second predetermined weight, S_Gain is a third predetermined weight, C_Gain1 is a fourth predetermined weight, C_Gain2 is a fifth predetermined weight, and Bass_Gain is a sixth predetermined weight. ⊕ represents an addition. FL is a second front left channel signal, FR is a second front right channel signal, SL is a second rear left channel signal, RL is a second rear right channel signal, C is a second center channel signal, and Bass is a bass channel signal. Then, FL, FR, SL, RL, C and Bass together form the 5.1-channel audio signal.

In an example, the audio upmixing method is performed by an audio upmixing model, and the audio upmixing method further includes: obtaining 5.1-channel audio source signals, selecting a target audio source signal from each of the 5.1-channel audio source signals, and extracting a 5-channel target audio signal from the target audio source signal; downmixing the 5-channel target audio signal to obtain a stereophonic training audio signal; extracting 5 channels of left channel audio signals and 5 channels of right channel audio signals from the stereophonic training audio signal based on the audio upmixing model, and incorporating the 5 channels of left channel audio signals and 5 channels of right channel audio signals into a 5-channel output audio signal; and optimizing the audio upmixing model based on a difference between the 5-channel target audio signal and the 5-channel output audio signal.

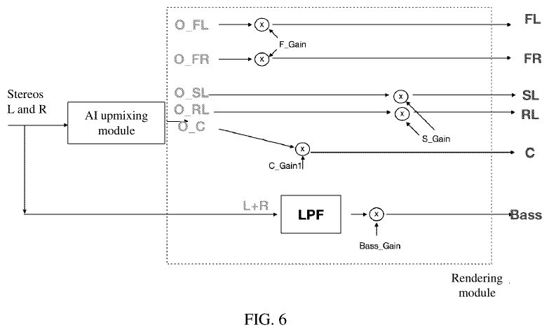

In an example, as an example, the finally generated audio upmixing signal of the target format is a 5.1-channel audio signal. Referring to FIG. 6, FIG. 6 is a schematic diagram of generating the 5.1-channel audio signal based on the original stereophonic signal according to another example. The original stereophonic signal may be directly designated as the stereophonic audio signal without separating the voice signal in the original stereophonic signal. Stereos L and R are stereophonic audio signals. An AI upmixing module is configured to generate first audio signals of a plurality of target channels based on the stereos. The first audio signals of the plurality of target channels includes a first front left channel signal O_FL, a first front right channel signal O_FR, a first rear left channel signal O_SL, a first rear right channel signal O_RL, a first center channel signal O_C. LPF is a low-pass filter. Based on a first predetermined weight F_Gain, the first front left channel signal O_FL may be directly weighted into a second front left channel signal FL, and the first front right channel signal O_FR may be directly weighted into FR. Based on a third predetermined weight S_Gain, the first rear left channel signal O_SL may be weighted into a second rear left channel signal SL, and the first rear right channel signal O_RL may be directly weighted into a second rear right channel signal RL. Based on a fourth predetermined weight C_Gain1, the first center channel signal O_C is directly weighted into a second center channel signal C. Based on a sixth predetermined weight Bass_Gain, the low-pass filtered stereos L and R are weighted into a bass channel signal Bass. Then, FL, FR, SL, RL, C and Bass together form the 5.1-channel audio signal.

The audio upmixing process of steps 202 to 208 described above may be executed by an audio upmixing model. When training the audio upmixing model, in order to ensure the training effect of the audio upmixing model, it is usually necessary to select a target audio source signal having a better training effect from a large number of 5.1-channel audio source signals to train the audio upmixing model.

Specifically, 5.1-channel audio source signals are obtained, a target audio source signal is selected from each of the 5.1-channel audio source signals, and a 5-channel target audio signal is extracted from the target audio source signal. The 5-channel target audio signal is downmixed based on a predetermined downmixing matrix, and the stereophonic signal obtained by the downmixing is designated as a stereophonic training audio signal. The following audio upmixing process is executed based on the audio upmixing model. The stereophonic training audio signal is converted from a time domain to a frequency domain to obtain a stereophonic frequency domain training signal. Frequency division is performed on the stereophonic frequency domain training signal to obtain a plurality of frequency-divided training signals. Feature extraction is performed on the plurality of frequency-divided training signals respectively to obtain a plurality of frequency-divided training signal features. The plurality of frequency-divided training signal features are fused based on a frequency division band bandwidth to obtain a stereophonic training audio feature. The stereophonic training audio feature is input into each of 10 audio output channels, 5 channels of left channel audio signals and 5 channels of right channel audio signals are output. The 5 channels of left channel audio signals and the 5 channels of right channel audio signals are weighted and fused into a 5-channel output audio signal. The audio upmixing model is iteratively updated and optimized based on a model loss calculated from the difference between the 5-channel target audio signal and the 5-channel output audio signal.

It should be noted that the audio upmixing process executed by the audio upmixing model may refer to the audio upmixing process according to the examples of the audio upmixing method described above, which will not be elaborated herein.

As an example, extracting the 5-channel target audio signal from the target audio source signal includes: removing the bass channel signal from the target audio source signal to obtain the 5-channel target audio signal.

As an example, extracting the 5-channel target audio signal from the target audio source signal includes: removing the bass channel signal and the voice signal from the target audio source signal to obtain a 5-channel target audio signal. It should be noted that the 5-channel target audio signal may be a front left channel signal, a front right channel signal, a rear left channel signal, a rear right channel signal, and a center channel signal in 5.1 audio signals.

In an example, optimizing the audio upmixing model based on the difference between the 5-channel target audio signal and the 5-channel output audio signal includes: generating a first model loss based on an overall signal difference between the 5-channel target audio signal and the 5-channel output audio signal; generating a second model loss based on a first volume difference of audio signals of different channels in the 5-channel target audio signal and a second volume difference of audio signals of different channels in the 5-channel output audio signal; and optimizing the audio upmixing model based on the first model loss and the second model loss.

Specifically, a first model loss is calculated based on an overall signal difference between the 5-channel target audio signal and the 5-channel output audio signal. A second model loss is calculated based on a first volume difference of audio signals of different channels in the 5-channel target audio signal and a second volume difference of audio signals of different channels in the 5-channel output audio signal. The first model loss and the second model loss are added to obtain a total model loss. The audio upmixing model is iteratively updated and optimized based on gradient information calculated based on the total model loss.

As an example, a formula for calculating the first model loss based on the overall signal difference between the 5-channel target audio signal and the 5-channel output audio signal is as follows:

L₁=20 log(target/estimate−target)

where L₁ represents the first model loss, target represents the 5-channel target audio signal, and estimate represents the 5-channel output audio signal.

As an example, calculating the second model loss based on the first volume difference of the audio signals of different channels in the 5-channel target audio signal and the second volume difference of the audio signals of different channels in the 5-channel output audio signal includes: calculating a first volume difference value between two audio signals of different channels in the 5-channel target audio signal; calculating a second volume difference value between two audio signals of different channels in the 5-channel output audio signal; and calculating a cumulative result of a difference between each group of the first volume difference value and the second volume difference value corresponding to audio signals of a same channel, and taking the cumulative result as a second model loss.

As an example, the method of selecting the target audio source signal from each 5.1-channel audio source signal includes at least one of the following methods.

In a first method, the target audio source signal is selected from the 5.1-channel audio source signal based on the correlation between the front left channel signal and the rear left channel signal, and the correlation between the front right channel signal and the rear right channel signal in the 5.1-channel audio source signal.

For the 5.1-channel audio source signal, when the correlation between the front left channel signal and the rear left channel signal is too high, or the correlation between the front right channel signal and the rear right channel signal is too high, the auditory effect of the 5.1-channel audio source signal is deteriorated.

Specifically, for each 5.1-channel audio source signal, a first correlation value between the front left channel signal and the rear left channel signal in the 5.1-channel audio source signal is calculated, and a second correlation value between the front right channel signal and the rear right channel signal in the 5.1-channel audio source signal is calculated. When each of the first correlation value and the second correlation value is less than a predetermined correlation threshold, the 5.1-channel audio source signal is designated as the target audio source signal. When either the first correlation value or the second correlation value is not less than the predetermined correlation threshold, the 5.1-channel audio source signal is not designated as the target audio source signal.

In a second method, the target audio source signal is selected from the 5.1-channel audio source signal based on signal energy of a rear surrounding channel signal in the 5.1-channel audio source signal. For the 5.1-channel audio source signal, when the signal energy of the rear surrounding channel signal is relatively small, it is easy to cause the 5.1-channel audio source signal to have no spatial auditory feeling of rear surround, resulting in poor auditory effect.

Specifically, for each 5.1-channel audio source signal, the signal energy of the rear surrounding channel signal in the 5.1-channel audio source signal is determined. When the signal energy exceeds a predetermined signal energy threshold, the 5.1-channel audio source signal is designated as the target audio source signal. When the signal energy does not exceed the predetermined signal energy threshold, the 5.1-channel audio source signal is not designated as the target audio source signal.

In the example, targeted training of the audio upmixing model is achieved, enabling the audio upmixing model to perform the aforementioned audio upmixing process. On one hand, the model loss can be reasonably determined based on the overall signal difference between the 5-channel target audio signal and the 5-channel output audio signal, the first volume difference of the audio signals of different channels in the 5-channel target audio signal, and the second volume difference of the audio signals of different channels in the 5-channel output audio signal. This allows the audio upmixing model to learn a more accurate 5-channel audio signal, ultimately enabling the generation of more accurate 5.1-channel audio signal. On the other hand, the 5.1-channel audio source signal can also be selected to ensure that the correlation between the front left channel signal and the rear left channel signal in the selected 5.1-channel audio source signal is low, and the correlation between the front right channel signal and the rear right channel signal is low; or to ensure that the signal energy of the rear surrounding channel signal in the selected 5.1-channel audio source signal is high. Therefore, the quality of training samples of the audio upmixing model can be improved, enhancing the accuracy of the trained audio upmixing model and laying a solid foundation for improved audio upmixing performance.

It should be understood that, although the steps in the flowcharts related to the examples described above are sequentially shown as indicated by arrows, the steps are not necessarily performed sequentially as indicated by the arrows. The steps are not limited to being performed in the exact order illustrated and, unless explicitly stated herein, the steps may be performed in other orders. Furthermore, at least a part of the steps in the flowcharts related to the examples described above may include a plurality of steps or a plurality of stages, the steps or stages are not necessarily performed at the same time, but may be performed at different times, the execution order of the steps or stages is not necessarily sequential, and the steps or stages do not necessarily need to be performed sequentially and may instead be executed alternately or concurrently with other steps, or with at least a portion of the steps or stages within other steps.

Based on the same inventive concept, an example of the present disclosure further provides an audio upmixing device for implementing the audio upmixing method described above. Since the implementation solution for solving the problem provided by the audio upmixing device is similar to the implementation solution described in the audio upmixing method described above, specific limitations in one or more examples of the audio upmixing device provided below can be referred to the limitations on the audio upmixing method described above, which will not be elaborated herein.

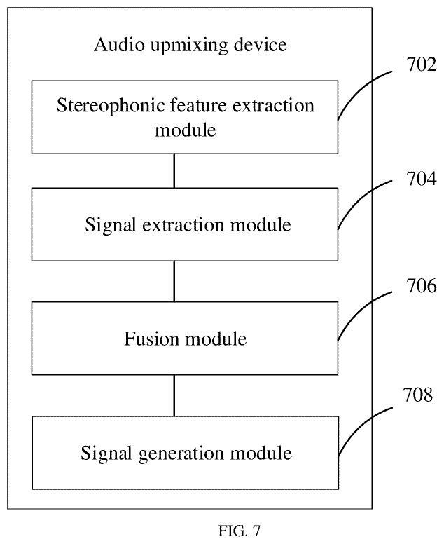

In an example, as shown in FIG. 7, an audio upmixing device is provided. The audio upmixing device includes a stereophonic feature extraction module 702, a signal extraction module 704, a fusion module 706, and a signal generation module 708, in which: the stereophonic feature extraction module 702 is configured to obtain a stereophonic audio signal and perform feature extraction on the stereophonic audio signal to obtain a stereophonic audio feature; the signal extraction module 704 is configured to extract a plurality of left channel audio signals and a plurality of right channel audio signals from the stereophonic audio feature based on a plurality of audio output channels, where the plurality of audio output channels are independent of each other, and each of the plurality of audio output channels is configured to output the corresponding left channel audio signal or the corresponding right channel audio signal; the fusion module 706 is configured to fuse the left channel audio signal and the right channel audio signal corresponding to a particular target channel to obtain first audio signals of a plurality of target channels, where each of the plurality of target channels corresponds to two of the plurality of audio output channels; and the signal generation module 708 is configured to output an audio upmixing signal of a target format based on the first audio signals of the plurality of target channels, where the target format corresponds to the plurality of target channels.

In an example, the stereophonic feature extraction module is further configured to: extract a positional audio feature from the stereophonic audio feature, in which the positional audio feature is used to represent sound source signal features of different positions of the stereophonic audio signal; and extract the plurality of left channel audio signals and the plurality of right channel audio signals from the positional audio feature based on the plurality of audio output channels.

In an example, the positional audio feature includes a first positional sound source signal feature and a second positional sound source signal feature of the stereophonic audio signal, and the plurality of audio output channels include a plurality of first fully-connected networks and a plurality of second fully-connected networks that are different from each other; and the signal extraction module is further configured to: output a corresponding left channel audio signal and a corresponding right channel audio signal through the plurality of first fully-connected networks by taking the first positional sound source signal feature as an input to the plurality of first fully-connected networks, in which each of the plurality of first fully-connected networks is configured to output the left channel audio signal or the right channel audio signal; and output a corresponding left channel audio signal and a corresponding right channel audio signal through the plurality of second fully-connected networks by taking the second positional sound source signal feature as an input to the plurality of second fully-connected networks, in which each of the plurality of second fully-connected networks is configured to output the left channel audio signal or the right channel audio signal.

In an example, the first audio signals of the plurality of target channels include a first front left channel signal of a front left channel, a first front right channel signal of a front right channel, a first rear left channel signal of a rear left channel, a first rear right channel signal of a rear right channel. The signal extraction module is further configured to: fuse a left channel audio signal and a right channel audio signal output by the first fully-connected network corresponding to the front left channel to obtain the first front left channel signal; fuse a left channel audio signal and a right channel audio signal output by the first fully-connected network corresponding to the front right channel to obtain the first front right channel signal; fuse a left channel audio signal and a right channel audio signal output by the first fully-connected network corresponding to the center channel to obtain the first center channel signal; fuse a left channel audio signal and a right channel audio signal output by the second fully-connected network corresponding to the rear left channel to obtain the first rear left channel signal; and fuse a left channel audio signal and a right channel audio signal output by the second fully-connected network corresponding to the rear right channel to obtain the first rear right channel signal.

In an example, the stereophonic feature extraction module is further configured to: obtain an original stereophonic signal, and perform voice separation on the original stereophonic signal to obtain a non-voice signal and a voice signal; and take the non-voice signal as the stereophonic audio signal.

In an example, the signal generation module is further configured to: incorporate the voice signal into each of the front left channel signal, the front right channel signal, and the center channel signal in the first audio signals of the plurality of target channels to obtain second audio signals of the plurality of target channels; and output the audio upmixing signal of the target format based on the second audio signals of the plurality of target channels.

In an example, the first audio signals of the plurality of target channels include a first front left channel signal, a first front right channel signal, a first rear left channel signal, a first rear right channel signal and a first center channel signal, the voice signal includes a left channel voice signal and a right channel voice signal, and the second audio signals of the plurality of target channels include a second front left channel signal, a second front right channel signal, a second rear left channel signal, a second rear right channel signal, and a second center channel signal. The signal generation module is further configured to: perform a weighted incorporation on the first front left channel signal and the left channel voice signal to obtain the second front left channel signal; perform the weighted incorporation on the first front right channel signal and the right channel voice signal to obtain the second front right channel signal; weight the first rear left channel signal to obtain the second rear left channel signal and weight the first rear right channel signal into the second rear right channel signal; and perform the weighted incorporation on the left channel voice signal, the right channel voice signal, and the first center channel signal to obtain the second center channel signal.

In an example, the audio upmixing method is performed by an audio upmixing model, and the audio upmixing device further includes: a training module configured to obtain 5.1-channel audio source signals, select a target audio source signal from each of the 5.1-channel audio source signals, and extract a 5-channel target audio signal from the target audio source signal; downmixing the 5-channel target audio signal to obtain a stereophonic training audio signal; extract 5 channels of left channel audio signals and 5 channels of right channel audio signals from the stereophonic training audio signal based on the audio upmixing model, and incorporate the 5 channels of left channel audio signals and 5 channels of right channel audio signals into a 5-channel output audio signal; and optimize the audio upmixing model based on a difference between the 5-channel target audio signal and the 5-channel output audio signal.

In an example, the training module is further configured to: generate a first model loss based on an overall signal difference between the 5-channel target audio signal and the 5-channel output audio signal; generate a second model loss based on a first volume difference of audio signals of different channels in the 5-channel target audio signal and a second volume difference of audio signals of different channels in the 5-channel output audio signal; and optimize the audio upmixing model based on the first model loss and the second model loss.

Each of the modules in the audio upmixing device described above may be implemented in whole or in part by software, hardware, and combinations thereof. Each of the modules described above may be embedded in or independent of a processor in the audio apparatus in hardware form, or may be stored in a memory in the audio apparatus in software form, so as to be invoked by the processor to perform the operation corresponding to the module.

In an example, an audio apparatus is provided. The audio apparatus may be a terminal, and its internal structural diagram may be as shown in FIG. 7. The audio apparatus includes a processor, a memory, a communication interface, a display screen, and an input device, that are connected by a system bus. The processor of the audio apparatus is configured to provide computing and control capabilities. The memory of the audio apparatus includes a non-volatile storage medium and an internal memory. The non-volatile storage medium stores an operating system and a computer program. The internal memory provides an environment for the operation of the operating system and the computer program in the non-volatile storage medium. The communication interface of the audio apparatus is configured for wired or wireless communication with an external terminal, and the wireless mode may be realized by WIFI, a mobile cellular network, NFC (near field communication), or other technologies. The computer program, when executed by the processor, implements the audio upmixing method.

Those skilled in the art may understand that the structure shown in FIG. 7 is a block diagram of a part of the structure related to the solution of the present disclosure, and does not constitute a limitation of the audio apparatus to which the solution of the present disclosure is applied. The specific audio apparatus may include more or fewer components than those shown in the figure, or incorporate some components, or have different arrangements of components.

In an example, there is further provided an audio apparatus including a memory and a processor, the memory having a computer program, and the processor executing the computer program to implement steps of each of the method examples described above.

In an example, there is provided a computer-readable storage medium having a computer program stored thereon. The computer program, when executed by a processor, implements the steps in each of the method examples described above.

In an example, there is provided a computer program product including a computer program that, when executed by a processor, implements the steps of the method examples described above.

Those of ordinary skill in the art will appreciate that all or part of the processes in the method of the above examples can be implemented by instructing related hardware by a computer program stored in a non-volatile non-transitory computer-readable storage medium, and when executed, the computer program can include the processes of the method examples. Any reference to memory, database, or other medium used in the examples of the present disclosure may include at least one of non-volatile memory and volatile memory. The non-volatile memory may include Read-Only Memory (ROM), a magnetic tape, a floppy disk, flash memory, optical memory, high-density embedded non-volatile memory, resistive variable memory (ReRAM), Magnetoresistive Random Access Memory (MRAM), Ferroelectric Random Access Memory (FRAM), Phase Change Memory (PCM), and Graphene memory, etc. The volatile memory may include Random Access Memory (RAM), external cache memory, or the like. By way of illustration and not limitation, the RAM may take various forms, such as Static Random Access Memory (SRAM) or Dynamic Random Access Memory (DRAM), and the like. The database according to the examples provided in the present disclosure may include at least one of a relational database and a non-relational database. The non-relational database may include a block chain-based distributed database or the like, but is not limited thereto. The processor according to the examples provided in the present disclosure may be a general-purpose processor, a central processing unit, a graphics processor, a digital signal processor, a programmable logic unit, a data processing logic unit based on quantum computing, or the like, but is not limited thereto.

The technical features in the above examples may be combined. For brevity of description, not all possible combinations of the technical features in the above examples are described. However, as long as a combination of these technical features is not contradictory, the combination should be considered to fall within the scope of the description.

The examples described above only express a few implementations of the present disclosure, and the description thereof is relatively specific and detailed, but should not be construed as limiting the scope of the present disclosure. It should be noted that for those skilled in the art, modifications and improvements can be made without departing from the concept of the present disclosure, and these are all within the protection scope of the present disclosure. Therefore, the protection scope of the present disclosure should be subject to the appended claims.

What is claimed is:

1. An audio upmixing method, comprising:
obtaining a stereophonic audio signal, and performing feature extraction on the stereophonic audio signal to obtain a stereophonic audio feature;
extracting, from the stereophonic audio feature based on a plurality of audio output channels, a plurality of left channel audio signals and a plurality of right channel audio signals, wherein the plurality of audio output channels are independent of each other, and each of the plurality of audio output channels is configured to output the corresponding left channel audio signal or the corresponding right channel audio signal;
fusing the left channel audio signal and the right channel audio signal corresponding to a target channel to obtain first audio signals of a plurality of target channels, wherein each of the plurality of target channels corresponds to two of the plurality of audio output channels; and
outputting, based on the first audio signals of the plurality of target channels, an audio upmixing signal of a target format, wherein the target format corresponds to the plurality of target channels.

2. The audio upmixing method according to claim 1, wherein the extracting the plurality of left channel audio signals and the plurality of right channel audio signals comprises:
extracting, from the stereophonic audio feature, a positional audio feature representing sound source signal features of different positions of the stereophonic audio signal; and
extracting, from the positional audio feature and based on the plurality of audio output channels, the plurality of left channel audio signals and the plurality of right channel audio signals.

3. The audio upmixing method according to claim 2, wherein the positional audio feature comprises a first positional sound source signal feature and a second positional sound source signal feature of the stereophonic audio signal, and the plurality of audio output channels comprise a plurality of first fully-connected networks and a plurality of second fully-connected networks that are different from each other, and wherein the extracting the plurality of left channel audio signals and the plurality of right channel audio signals comprises:
outputting, based on an input comprising the first positional sound source signal feature and using the plurality of first fully-connected networks, a corresponding left channel audio signal and a corresponding right channel audio signal, wherein each of the plurality of first fully-connected networks is configured to output the left channel audio signal or the right channel audio signal; and
outputting, based on an input comprising the second positional sound source signal feature and using the plurality of second fully-connected networks, a corresponding left channel audio signal and a corresponding right channel audio signal, wherein each of the plurality of second fully-connected networks is configured to output the left channel audio signal or the right channel audio signal.

4. The audio upmixing method according to claim 3, wherein the first audio signals of the plurality of target channels comprise a first front left channel signal of a front left channel, a first front right channel signal of a front right channel, a first rear left channel signal of a rear left channel, a first rear right channel signal of a rear right channel, and a first center channel signal of a center channel, and wherein the fusing the left channel audio signal and the right channel audio signal comprises:
fusing a left channel audio signal and a right channel audio signal output by a first fully-connected network corresponding to the front left channel to obtain the first front left channel signal;
fusing a left channel audio signal and a right channel audio signal output by a first fully-connected network corresponding to the front right channel to obtain the first front right channel signal;
fusing a left channel audio signal and a right channel audio signal output by a first fully-connected network corresponding to the center channel to obtain the first center channel signal;
fusing a left channel audio signal and a right channel audio signal output by a second fully-connected network corresponding to the rear left channel to obtain the first rear left channel signal; and
fusing a left channel audio signal and a right channel audio signal output by a second fully-connected network corresponding to the rear right channel to obtain the first rear right channel signal.

5. The audio upmixing method according to claim 1, wherein the obtaining the stereophonic audio signal comprises:
obtaining an original stereophonic signal;
performing voice separation on the original stereophonic signal to obtain a non-voice signal and a voice signal; and
taking the non-voice signal as the stereophonic audio signal.

6. The audio upmixing method according to claim 5, wherein the outputting the audio upmixing signal of the target format comprises:
incorporating the voice signal into each of a front left channel signal, a front right channel signal, and a center channel signal in the first audio signals of the plurality of target channels to obtain second audio signals of the plurality of target channels; and
outputting the audio upmixing signal of the target format based on the second audio signals of the plurality of target channels.

7. The audio upmixing method according to claim 6, wherein the first audio signals of the plurality of target channels comprise a first front left channel signal, a first front right channel signal, a first rear left channel signal, a first rear right channel signal and a first center channel signal, the voice signal comprises a left channel voice signal and a right channel voice signal, and the second audio signals of the plurality of target channels comprise a second front left channel signal, a second front right channel signal, a second rear left channel signal, a second rear right channel signal, and a second center channel signal, and wherein the incorporating the voice signal comprises:
performing a weighted incorporation on the first front left channel signal and the left channel voice signal to obtain the second front left channel signal;
performing the weighted incorporation on the first front right channel signal and the right channel voice signal to obtain the second front right channel signal;
weighting the first rear left channel signal to obtain the second rear left channel signal, and weighting the first rear right channel signal into the second rear right channel signal; and
performing the weighted incorporation on the left channel voice signal, the right channel voice signal, and the first center channel signal to obtain the second center channel signal.

8. The audio upmixing method according to claim 1, wherein the audio upmixing method is performed by an audio upmixing model, and the audio upmixing method further comprises:
obtaining 5.1-channel audio source signals, selecting a target audio source signal from each of the 5.1-channel audio source signals, and extracting a 5-channel target audio signal from the target audio source signal;
downmixing the 5-channel target audio signal to obtain a stereophonic training audio signal;
extracting, from the stereophonic training audio signal and based on the audio upmixing model, 5 channels of left channel audio signals and 5 channels of right channel audio signals, and incorporating the 5 channels of left channel audio signals and 5 channels of right channel audio signals into a 5-channel output audio signal; and
optimizing the audio upmixing model based on a difference between the 5-channel target audio signal and the 5-channel output audio signal.

9. The audio upmixing method according to claim 8, wherein the optimizing the audio upmixing model comprises:
generating a first model loss based on an overall signal difference between the 5-channel target audio signal and the 5-channel output audio signal;
generating a second model loss based on a first volume difference of audio signals of different channels in the 5-channel target audio signal and a second volume difference of audio signals of different channels in the 5-channel output audio signal; and
optimizing the audio upmixing model based on the first model loss and the second model loss.

10. An audio apparatus, comprising:
one or more processors; and
memory storing computer-readable instructions that, when executed by the one or more processors, cause the audio apparatus to:
obtain a stereophonic audio signal, and performing feature extraction on the stereophonic audio signal to obtain a stereophonic audio feature;
extract, from the stereophonic audio feature based on a plurality of audio output channels, a plurality of left channel audio signals and a plurality of right channel audio signals, wherein the plurality of audio output channels are independent of each other, and each of the plurality of audio output channels is configured to output the corresponding left channel audio signal or the corresponding right channel audio signal;
fuse the left channel audio signal and the right channel audio signal corresponding to a target channel to obtain first audio signals of a plurality of target channels, wherein each of the plurality of target channels corresponds to two of the plurality of audio output channels; and
output, based on the first audio signals of the plurality of target channels, an audio upmixing signal of a target format, wherein the target format corresponds to the plurality of target channels.

11. The audio apparatus according to claim 10, wherein the computer-readable instructions, when executed by the one or more processors, further cause the audio apparatus to extract the plurality of left channel audio signals and the plurality of right channel audio signals by:
extracting, from the stereophonic audio feature, a positional audio feature representing sound source signal features of different positions of the stereophonic audio signal; and
extracting, from the positional audio feature and based on the plurality of audio output channels, the plurality of left channel audio signals and the plurality of right channel audio signals.

12. The audio apparatus according to claim 11, wherein the positional audio feature comprises a first positional sound source signal feature and a second positional sound source signal feature of the stereophonic audio signal, and the plurality of audio output channels comprise a plurality of first fully-connected networks and a plurality of second fully-connected networks that are different from each other, and wherein the computer-readable instructions, when executed by the one or more processors, further cause the audio apparatus to extract the plurality of left channel audio signals and the plurality of right channel audio signals by:
outputting, based on an input comprising the first positional sound source signal feature and using the plurality of first fully-connected networks, a corresponding left channel audio signal and a corresponding right channel audio signal, wherein each of the plurality of first fully-connected networks is configured to output the left channel audio signal or the right channel audio signal; and
outputting, based on an input comprising the second positional sound source signal feature and using the plurality of second fully-connected networks, a corresponding left channel audio signal and a corresponding right channel audio signal, wherein each of the plurality of second fully-connected networks is configured to output the left channel audio signal or the right channel audio signal.

13. The audio apparatus according to claim 12, wherein the first audio signals of the plurality of target channels comprise a first front left channel signal of a front left channel, a first front right channel signal of a front right channel, a first rear left channel signal of a rear left channel, a first rear right channel signal of a rear right channel, and a first center channel signal of a center channel, and wherein the computer-readable instructions, when executed by the one or more processors, further cause the audio apparatus to fuse the left channel audio signal and the right channel audio signal by:
fusing a left channel audio signal and a right channel audio signal output by a first fully-connected network corresponding to the front left channel to obtain the first front left channel signal;
fusing a left channel audio signal and a right channel audio signal output by a first fully-connected network corresponding to the front right channel to obtain the first front right channel signal;
fusing a left channel audio signal and a right channel audio signal output by a first fully-connected network corresponding to the center channel to obtain the first center channel signal;
fusing a left channel audio signal and a right channel audio signal output by a second fully-connected network corresponding to the rear left channel to obtain the first rear left channel signal; and
fusing a left channel audio signal and a right channel audio signal output by a second fully-connected network corresponding to the rear right channel to obtain the first rear right channel signal.

14. The audio apparatus according to claim 10, wherein the computer-readable instructions, when executed by the one or more processors, further cause the audio apparatus to obtain the stereophonic audio signal by:
obtaining an original stereophonic signal;
performing voice separation on the original stereophonic signal to obtain a non-voice signal and a voice signal; and
taking the non-voice signal as the stereophonic audio signal.

15. The audio apparatus according to claim 14, wherein the computer-readable instructions, when executed by the one or more processors, further cause the audio apparatus to output the audio upmixing signal of the target format by:
incorporating the voice signal into each of a front left channel signal, a front right channel signal, and a center channel signal in the first audio signals of the plurality of target channels to obtain second audio signals of the plurality of target channels; and
outputting the audio upmixing signal of the target format based on the second audio signals of the plurality of target channels.

16. The audio apparatus according to claim 15, wherein the first audio signals of the plurality of target channels comprise a first front left channel signal, a first front right channel signal, a first rear left channel signal, a first rear right channel signal and a first center channel signal, the voice signal comprises a left channel voice signal and a right channel voice signal, and the second audio signals of the plurality of target channels comprise a second front left channel signal, a second front right channel signal, a second rear left channel signal, a second rear right channel signal, and a second center channel signal, and wherein the computer-readable instructions, when executed by the one or more processors, further cause the audio apparatus to incorporate the voice signal by:
performing a weighted incorporation on the first front left channel signal and the left channel voice signal to obtain the second front left channel signal;
performing the weighted incorporation on the first front right channel signal and the right channel voice signal to obtain the second front right channel signal;
weighting the first rear left channel signal to obtain the second rear left channel signal, and weighting the first rear right channel signal into the second rear right channel signal; and
performing the weighted incorporation on the left channel voice signal, the right channel voice signal, and the first center channel signal to obtain the second center channel signal.

17. The audio apparatus according to claim 10, wherein the computer-readable instructions, when executed by the one or more processors, further cause the audio apparatus to:
obtain 5.1-channel audio source signals, selecting a target audio source signal from each of the 5.1-channel audio source signals, and extracting a 5-channel target audio signal from the target audio source signal;
downmix the 5-channel target audio signal to obtain a stereophonic training audio signal;
extract, from the stereophonic training audio signal and based on an audio upmixing model, 5 channels of left channel audio signals and 5 channels of right channel audio signals, and incorporating the 5 channels of left channel audio signals and 5 channels of right channel audio signals into a 5-channel output audio signal; and
optimize the audio upmixing model based on a difference between the 5-channel target audio signal and the 5-channel output audio signal.

18. The audio apparatus according to claim 17, wherein the computer-readable instructions, when executed by the one or more processors, further cause the audio apparatus to optimize the audio upmixing model by:
generating a first model loss based on an overall signal difference between the 5-channel target audio signal and the 5-channel output audio signal;
generating a second model loss based on a first volume difference of audio signals of different channels in the 5-channel target audio signal and a second volume difference of audio signals of different channels in the 5-channel output audio signal; and
optimizing the audio upmixing model based on the first model loss and the second model loss.

19. A non-transitory machine-readable medium storing instructions that, when executed by one or more processors, cause the one or more processors to perform steps comprising:
obtaining a stereophonic audio signal, and performing feature extraction on the stereophonic audio signal to obtain a stereophonic audio feature;
extracting, from the stereophonic audio feature based on a plurality of audio output channels, a plurality of left channel audio signals and a plurality of right channel audio signals, wherein the plurality of audio output channels are independent of each other, and each of the plurality of audio output channels is configured to output the corresponding left channel audio signal or the corresponding right channel audio signal;
fusing the left channel audio signal and the right channel audio signal corresponding to a target channel to obtain first audio signals of a plurality of target channels, wherein each of the plurality of target channels corresponds to two of the plurality of audio output channels; and
outputting, based on the first audio signals of the plurality of target channels, an audio upmixing signal of a target format, wherein the target format corresponds to the plurality of target channels.

20. The non-transitory machine-readable medium of claim 19, wherein the instructions, when executed by one or more processors, cause the one or more processors to perform steps comprising:
extracting, from the stereophonic audio feature, a positional audio feature representing sound source signal features of different positions of the stereophonic audio signal; and
extracting, from the positional audio feature and based on the plurality of audio output channels, the plurality of left channel audio signals and the plurality of right channel audio signals.
